(19) United States
(12) Patent Application Publication
(10) Pub. No.: US 2005/0154982 A1
(43) Pub. Date: Jul. 14, 2005

(54) Apparatus, system and method of importing cascading style sheets to macromedia flash

(75) Inventor: Jeffrey Carroll Berg, Chicago, IL (US)

Correspondence Address: Mr. Volel Emille, P.O. Box 202170, Austin, TX, 78720-2170, US

(73) Assignee: International Business Machines Corporation, Armonk, NY (US)

(21) Appl. No.: 10/756,137

(22) Filed: Jan. 13, 2004

(51) Int. Cl. G06F 17/24

(52) U.S. Cl. 715/523

(57) ABSTRACT

A system, apparatus and method of importing a Cascading Style Sheets (CSS) file into a Flash-based Web page are provided. The system, apparatus, and method entail linking the flash-based Web page to the CSS file using an application program interface (API). The API includes a parser for parsing the CSS file for CSS attributes. The CSS attributes may include margin attributes to control vertical layouts of the Web page, line heights and global properties. After parsing the CSS attributes, they are converted into native Flash attributes before importing into the Flash-based Web page.

### BACKGROUND OF THE INVENTION

1. Technical Field

The present invention is directed to cascading style sheets. More specifically, the present invention is directed to an apparatus, system and method of importing cascading style sheets into Macromedia Flash.

2. Description of Related Art

A style sheet is a file that defines the layout of a Web document or page. Using a style sheet, designers and users may define how different elements (i.e., headers, page sizes, margins, fonts, links etc.), may appear in a Web page. Once a style sheet has been designed, it may be applied to any Web page. Note that more than one style sheet may be applied to a Web page. In this case, it is referred to as cascading style sheets (CSS).

CSS allows display (style) instructions to be separated from Web page contents. This makes it easy for authors to update and maintain their Web pages, especially if the pages are a single document that is linked to different pages or files of a web site. Style changes made in the document may be implemented across the site. For this reason, CSS has quickly become the standard for controlling the presentation of the content of Web applications.

Flash, a product of Macromedia, Inc., is a rapidly build data-driven rich suite of Internet applications. A familiar forms-based development environment and powerful data binding make it easy for visual application developers to build rich, effective applications for e-commerce, corporate intranets and more. Because of its ease of use and capability, Flash is being used more and more to design Web sites.

Until recently, however, Flash could not use existing CSS documents. That is, in-line styles had to be created for each page of a Flash-based Web site. Consequently, to change the styles (i.e., presentation) of such a Web site, an author had to manually and painstakingly change the styles of each page of the Web sites.

With the introduction of Flash MX 2004 Pro, however, external CSS documents may be loaded onto Flash. Thus, a Flash movie, for example, may load the very same CSS document used by the Web page on which it plays. In other words, a paragraph in a Flash player text field may appear exactly the same way as a paragraph in an html document. But, Flash MX 2004 Pro does not or cannot process all CSS attributes. For example, if a header or paragraph elements contained top and bottom margin attributes to control vertical layouts of a Web page, the Flash player would fail to pick up those properties, and would place each block directly under one another without any spacing. Further, line-heights may not be applied via CSS either.

Another limitation of Flash is that a global property to set a default typeface may not be set. Most well-formed CSS documents set a default face in the body element in order to obviate reapplying the font choice to all other elements. Thus, a font family, size, and color have to be stipulated for each and every element for a Flash content to appear correctly.

Thus, what is needed is an apparatus, system and method of fully importing CSS into Flash.

### SUMMARY OF THE INVENTION

The present invention provides system, apparatus and method of importing a Cascading Style Sheets (CSS) file into a Flash-based Web page. The system, apparatus, and method entail linking the flash-based Web page to the CSS file using an application program interface (API). The API includes a parser for parsing the CSS file for CSS attributes. The CSS attributes may include margin attributes to control vertical layouts of the Web page, line heights and global properties. After parsing the CSS attributes, they are converted into native Flash attributes before being importing into the Flash-based Web page.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1a depicts an exemplary CSS file.

FIG. 1b is an HTML document that uses a style from FIG. 1a.

FIG. 2 depicts an exemplary piece of code that may be used to import a CSS into Flash.

FIG. 3 is a “get method” that can be by the present invention.

FIG. 4 is an exemplary usage of the invention.

FIG. 5 is an exemplary block diagram of a computer system on which the present invention may be implemented.

### DETAILED DESCRIPTION OF THE PREFERRED EMBODIMENT

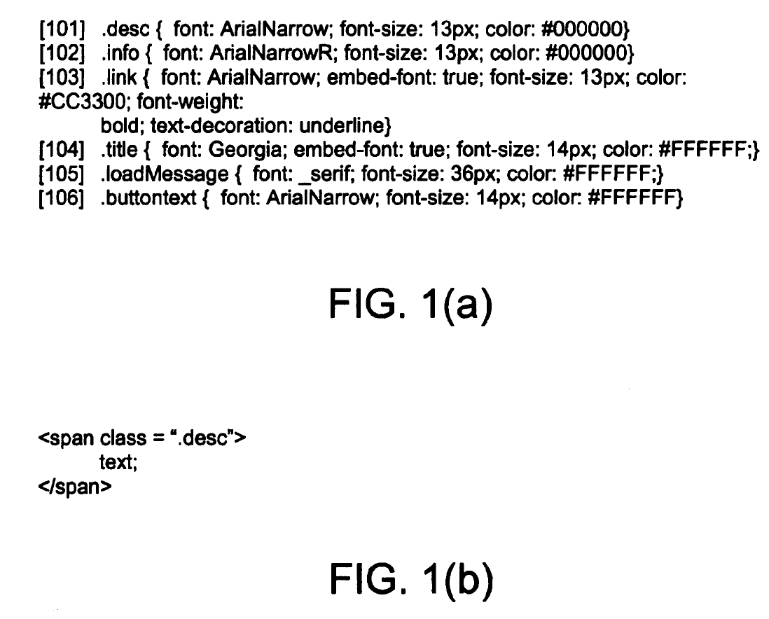

Turning to the figures, FIG. 1a depicts an exemplary CSS file. Each numbered line (i.e., lines 101-106) in the CSS file is a style. A style is a rule which ordinarily contains a selector and at least one declaration within curly braces. The format of a rule is: selector {property1: value1; property2: value2; etc.}

A selector is used as a link between an HTML document and a style. It specifies the elements that are affected by the declaration. A declaration is that part of the style that sets forth what the effect will be. For example, on line 101 of FIG. 1, there is one selector (i.e., .desc) and three declarations, each separated by a semi-colon (i.e., font: ArialNarrow; font-size: 13px; color: #000000). Hence, all .desc elements will be affected by the declarations. That is, they will use ArialNarrow as a font, the size of the characters will be 13 points and their color will be the color represented by #000000.

FIG. 1b is an HTML document that uses the style on line 101 of FIG. 1a. The text which appears between <span class=“.desc”> and </span> will use 13 points ArialNarrow characters of the color represented by #000000 when rendered on a screen or printed using a color printer. Note that if the other selectors (i.e., .info, .link, .title, .loadMessage and .buttontext on lines 102, 103, 104, 105 and 106, respectively), are used in the same or different HTML documents, the font, size, color etc. of the characters in the text will be in accordance with the respective declarations.

Thus, a Web author may design a CSS file as the one in FIG. 1a and link a plurality of Web pages thereto. This allows the author to easily update and maintain the Web pages. For example, if the author decides to update the Web pages by using a different font or color or both, the author may merely change the font or the color on line 101 and the font of all the Web pages that are linked thereto will accordingly change.

As mentioned earlier, Flash presently does not fully integrate with CSS. The present invention provides a system, apparatus and method that allows for a full integration of CSS and Flash.

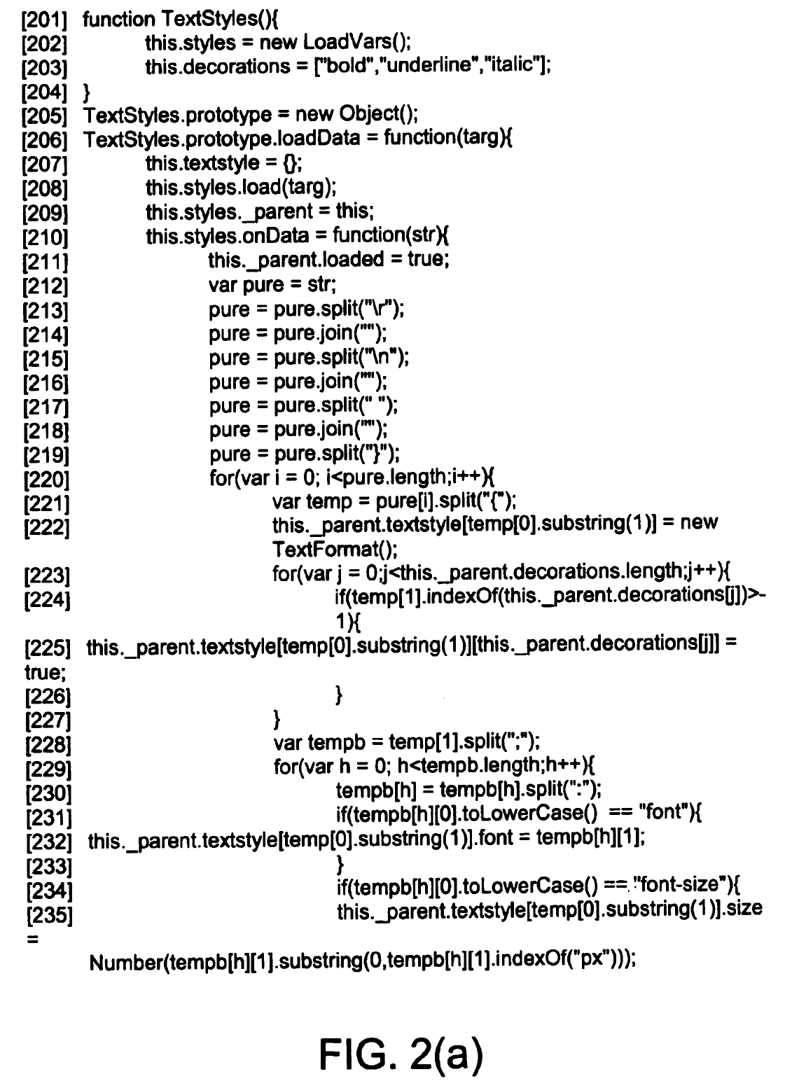

FIG. 2 depicts an exemplary piece of code that may be used to import the CSS of FIG. 1a into Flash. Particularly, on Lines 201 to 204, initial object and basic starting attributes are defined. For example, the bucket into which the raw data is loaded is defined as “new LoadVars( )” (see line 202). Likewise, a list of text decorations is defined (line 203). On line 205, the class type is declared to be an object and on lines 206-209 the data bucket created on line 202 is loaded with data. On lines 210-227, the data in the bucket is transformed into Flash native. The code on lines 228-230 separates properties from the CSS style which are not true or false conditions. The entire section on lines 231-240 checks for specfic properties and their values and places them into Flash format object.

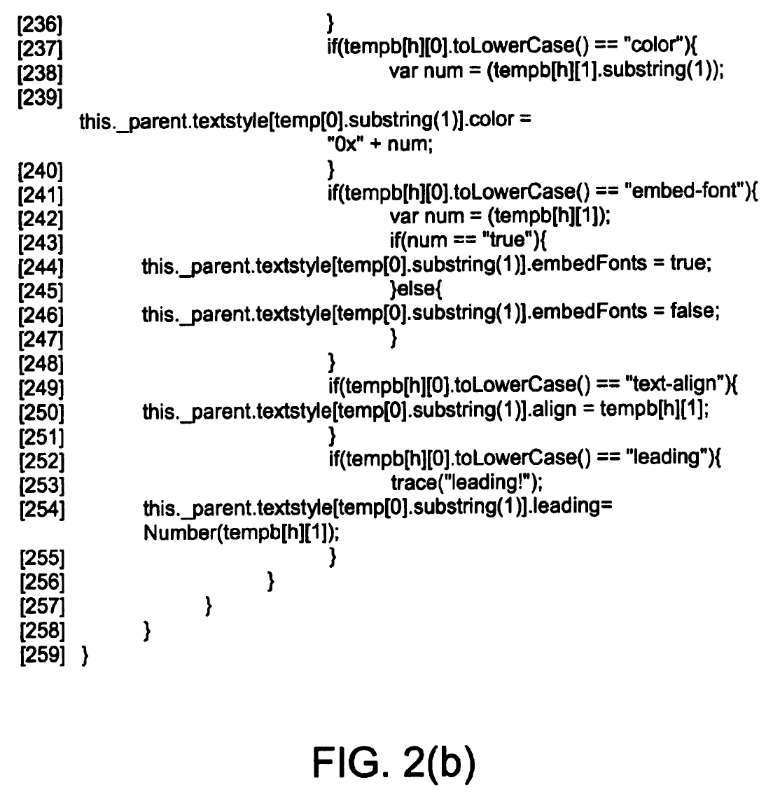

Embed-font is a Flash exception and must be checked in case the developer chooses to use vector fonts. This is done on lines 241-255. To retrieve the data stored into the native Flash format object created earlier, the get method in FIG. 3 is used.

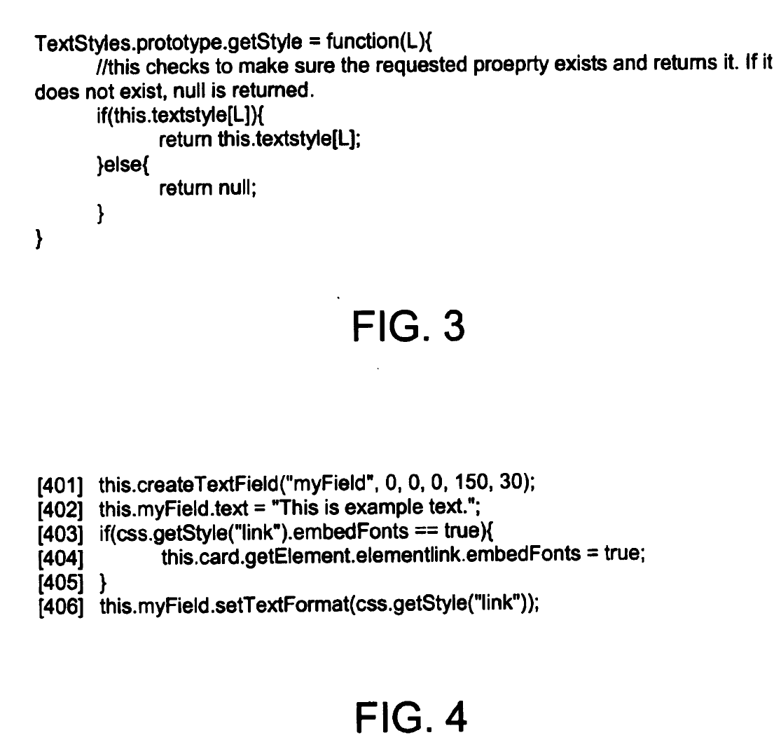

FIG. 4 is an exemplary usage of the invention. On line 401 a textfield is created. On line 402, text is inserted in the field. On line 404, a check is made to determine whether the developer wishes to use embedded fonts. On line 406 the style is declared on the field using the get method of FIG. 3.

Thus, the invention may be used as a plug-in to make all pre-MX 2004 Pro Flash products able to use CSS. Further, the invention may be used to make Flash MX 2004 Pro fully compatible with CSS.

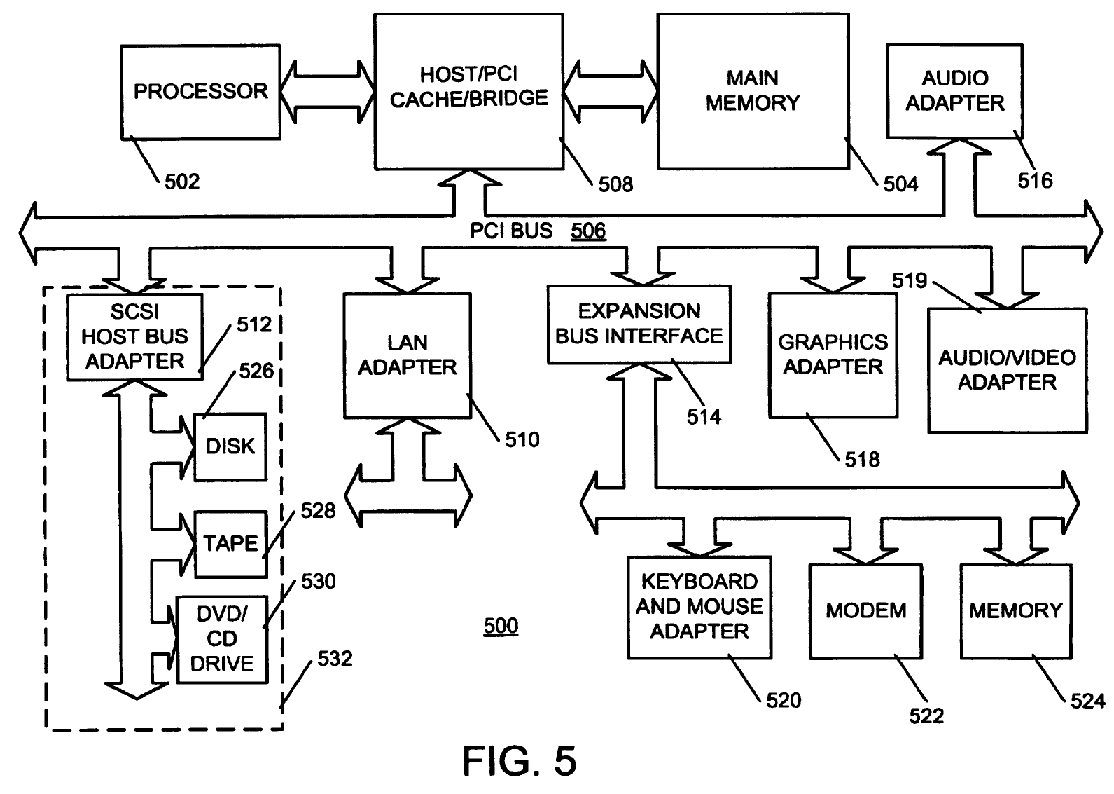

With reference now to FIG. 5, a block diagram illustrating a data processing system is depicted in which the present invention may be implemented. Data processing system 500 is an example of a client computer. Data processing system 500 employs a peripheral component interconnect (PCI) local bus architecture. Although the depicted example employs a PCI bus, other bus architectures such as Accelerated Graphics Port (AGP) and Industry Standard Architecture (ISA) may be used. Processor 502 and main memory 504 are connected to PCI local bus 506 through PCI bridge 508. PCI bridge 508 also may include an integrated memory controller and cache memory for processor 502. Additional connections to PCI local bus 506 may be made through direct component interconnection or through add-in boards. In the depicted example, local area network (LAN) adapter 510, SCSI host bus adapter 512, and expansion bus interface 514 are connected to PCI local bus 506 by direct component connection. In contrast, audio adapter 516, graphics adapter 518, and audio/video adapter 519 are connected to PCI local bus 506 by add-in boards inserted into expansion slots. Expansion bus interface 514 provides a connection for a keyboard and mouse adapter 520, modem 522, and additional memory 524. Small computer system interface (SCSI) host bus adapter 512 provides a connection for hard disk drive 526, tape drive 528, and CD-ROM/DVD drive 530. Typical PCI local bus implementations will support three or four PCI expansion slots or add-in connectors.

An operating system runs on processor 502 and is used to coordinate and provide control of various components within data processing system 500 in FIG. 5. The operating system may be a commercially available operating system, such as Windows XP™, which is available from Microsoft Corporation. An object oriented programming system such as Java may run in conjunction with the operating system and provide calls to the operating system from Java programs or applications executing on data processing system 500. “Java” is a trademark of Sun Microsystems, Inc. Instructions for the operating system, the object-oriented operating system, and applications or programs are located on storage devices, such as hard disk drive 526, and may be loaded into main memory 504 for execution by processor 502.

Those of ordinary skill in the art will appreciate that the hardware in FIG. 5 may vary depending on the implementation. Other internal hardware or peripheral devices, such as flash ROM (or equivalent nonvolatile memory) or optical disk drives and the like, may be used in addition to or in place of the hardware depicted in FIG. 5. Also, the processes of the present invention may be applied to a multiprocessor data processing system.

As another example, data processing system 500 may be configured to be bootable without relying on some type of network communication interface, whether or not data processing system 500 comprises some type of network communication interface. As a further example, data processing system 500 may be a Personal Digital Assistant (PDA) device, which is configured with ROM and/or flash ROM in order to provide non-volatile memory for storing operating system files and/or user-generated data.

The depicted example in FIG. 5 and above-described examples are not meant to imply architectural limitations. For example, data processing system 500 may also be a notebook computer or hand held computer in addition to taking the form of a PDA. Data processing system 500 also may be a kiosk or a Web appliance.

The description of the present invention has been presented for purposes of illustration and description, and is not intended to be exhaustive or limited to the invention in the form disclosed. Many modifications and variations will be apparent to those of ordinary skill in the art. Thus, the embodiment was chosen and described in order to best explain the principles of the invention, the practical application, and to enable others of ordinary skill in the art to understand the invention for various embodiments with various modifications as are suited to the particular use contemplated.

1. A method of importing a Cascading Style Sheets (CSS) file into a Flash-based Web page comprising the steps of:
linking the flash-based Web page to the CSS file using an application program interface (API), the API including a parser for parsing the CSS file for CSS attributes, the CSS attributes including margin attributes to control vertical layouts of the Web page;
converting the CSS attributes into native Flash attributes; and
importing the converted CSS attributes into the Flash-based Web page.

2. The method of claim 1 wherein the CSS attributes further include line heights.

3. The method of claim 2 wherein the CSS attributes further include global attributes.

4. A computer program product on a computer readable medium for importing a Cascading Style Sheets (CSS) file into a Flash-based Web page comprising:
code means for linking the flash-based Web page to the CSS file using an application program interface (API), the API including a parser for parsing the CSS file for CSS attributes, the CSS attributes including margin attributes to control vertical layouts of the Web page;
code means for converting the CSS attributes into native Flash attributes; and
code means for importing the converted CSS attributes into the Flash-based Web page.

5. The computer program product of claim 4 wherein the CSS attributes further include line heights.

6. The computer program product of claim 5 wherein the CSS attributes further include global attributes.

7. An apparatus for importing a Cascading Style Sheets (CSS) file into a Flash-based Web page comprising:
means for linking the flash-based Web page to the CSS file using an application program interface (API), the API including a parser for parsing the CSS file for CSS attributes, the CSS attributes including margin attributes to control vertical layouts of the Web page;
means for converting the CSS attributes into native Flash attributes; and
means for importing the converted CSS attributes into the Flash-based Web page.

8. The apparatus of claim 7 wherein the CSS attributes further include line heights.

9. The apparatus of claim 8 wherein the CSS attributes further include global attributes.

10. A system for importing a Cascading Style Sheets (CSS) file into a Flash-based Web page comprising:
at least one storage device for storing code data; and
at least one processor for processing the code data to link the flash-based Web page to the CSS file using an application program interface (API), the API including a parser for parsing the CSS file for CSS attributes, the CSS attributes including margin attributes to control vertical layouts of the Web page, to convert the CSS attributes into native Flash attributes, and to import the converted CSS attributes into the Flash-based Web page.

11. The system of claim 10 wherein the CSS attributes further include line heights.

12. The system of claim 11 wherein the CSS attributes further include global attributes.
